(19) United States
(12) Patent Application Publication
(10) Pub. No.: US 2023/0226514 A1
(43) Pub. Date: Jul. 20, 2023

(54) METHOD OF CHEMICAL REACTION IN A HEAT EXCHANGER REACTOR

(71) Applicant: Devang JHAVERI, Mumbai (IN)

(72) Inventor: Devang JHAVERI, Mumbai (IN)

(21) Appl. No.: 18/094,366

(22) Filed: Jan. 8, 2023

Related U.S. Application Data
(63) Continuation of application No. PCT/IN2021/050430, filed on May 3, 2021.

(30) Foreign Application Priority Data
Jan. 23, 2021 (IN) 202121003261

(51) Int. Cl. B01J 19/24; B01J 19/00

(52) U.S. Cl. CPC B01J 19/2415; B01J 19/0053; B01J 2208/0084

(57) ABSTRACT

The present invention provides a highly effective method of continuous reactions in a heat exchanger reactor using a flexible turbulator (2). The flexible turbulator (2) present in the tube of the reactor assembly provides efficient mixing and reaction of the reactants in the reactor. The tube and shell assembly provides better heat transfer by transfer of heat through the temperature gradient across the tube (3) wall. The shell fluid (8) can be cold or hot as required depending on whether the reaction is exothermic or endothermic. The reactants are passed through the inlet (6) and allowed to mix and react in the tube (3), the mixing and reaction is facilitated by flexible turbulator and the final product is received through the outlet. The process can be repeated to achieve desired final product. Progress of the reaction is measured by thermal sensors present inside the reactor. The data is processed through a highly specialized computer software and output about progress of reaction is monitored.

### CROSS-REFERENCE TO RELATED APPLICATIONS

This Application is a CONTINUATION application claiming the benefit of priority of the co-pending International Patent Application No. PCT/IN2021/050430 with an international filing date 3 May 2021 that designated the United States, which claims the benefit of priority of the Republic of INDIA Patent Application No. 202121003261, filed 23 Jan. 2021, the entire disclosures of each (and all) of which Applications are expressly incorporated by reference in their entirety herein.

### TECHNICAL FIELD OF INVENTION

The present invention generally relates to a highly effective method of continuous reactions in a heat exchanger reactor using a flexible turbulator.

### BACKGROUND

The conventional chemical reactors are usually huge cylindrical tanks with one or more mechanical stirrers. The reactions occurring inside the reaction tanks or the reactors can be endothermic or exothermic and requires a system in which the cylindrical tank is enclosed in a jacket or coil or incorporates within its body a tubular coil for heating/cooling fluid circulation. through which another fluid or steam is circulated as required. Further, the reaction can generate high pressure causing the need to build reactor tanks with thick walls. Furthermore, it can be difficult to control temperature over minor ranges in a large tank for temperature sensitive reactants having a high risk of deterioration of final product. One of such reactors is illustrated in patent application number CN107790089A in which the cylindrical reactor comprises of multiple compartments wherein the reactants are added through the inlet and the reactants are left to react. Further, the apparatus in the said patent application is made for batch reactions and not continuous/inlet reactions.

### OBJECTIVES OF INVENTION

The primary objective of the present invention is to provide a method for highly efficient reaction of more than two reactants in a tube and shell apparatus using a flexible turbulator.

Another objective of the present invention is to provide a method to reduce the size of equipment or apparatus required to carry out reaction.

Yet another objective of the present invention is to provide a method for continuous reaction with same efficiency.

Yet another objective of the present invention is to provide a method to reduce corrosion or lumen formation on the inner side of the reaction vessel or the tube.

These and other objects and advantages of the embodiments will become readily apparent from the following detailed description taken in conjunction with the accompanying drawings.

### SUMMARY OF THE INVENTION

Before the present method is described, it is to be understood that this application is not limited to the method described, as there can be multiple possible embodiments which are not expressly illustrated in the present disclosure. It is also to be understood that the terminology used in the description is for the purpose of describing the version or embodiments only and is not intended to limit the scope of the present application.

Various embodiments of the present invention provides a reactor for highly efficient reaction of two or more reactants in a continuous manner and its method thereof.

In an embodiment, a chemical reactor having more than one shell and tube apparatus has been provided.

In another embodiment, the chemical reactor contains a flexible turbulator for efficient and homogenous mixing of the reactants inside the tube.

In another embodiment, the method comprises of inlet of two or more reactants in the tube containing flexible turbulator and stirring of flexible turbulator that the gas is broken down into small bubbles or the solids are broken down ad mixed efficiently with the fluids.

In yet another embodiment, the method comprises of a shell fluid present outside the tube to provide or absorb heat passed through the wall of the tube across the temperature gradient in exothermic or endothermic reactions to maintain optimum temperature of the reaction.

In yet another embodiment, the method comprises of monitoring of heat transfer across the temperature gradient by means of thermal sensors placed inside the reactor. The temperature of the reaction gives data about the progress of the reaction which is monitored using computer system.

In yet another embodiment, the method of addition of reactants can be in any of the following ways:
i. Mixing all the reactants in the beginning.
ii. Gradually introduce reactants over different passes.
iii. Vary speed of addition of reactants together or sequentially in the reactor.

In yet another embodiment, a re-circulation tank can be added to the reactor assembly to recirculate the mixture of reactants till the process is complete.

### BRIEF DESCRIPTION OF DRAWINGS

FIG. 1 illustrates a single shell and tube apparatus with flexible turbulator

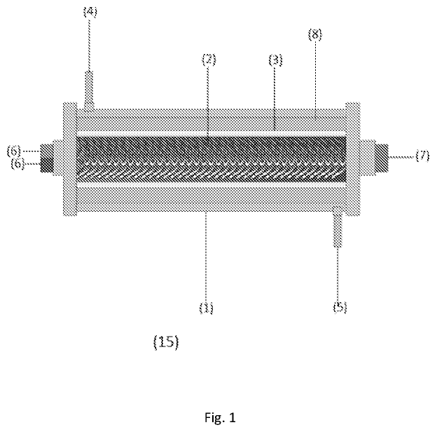

FIG. 2 illustrates a flexible turbulator.

FIG. 3 (a) illustrates a simple tube with flexible turbulator, and FIG. 3 (b) illustrates a fin tube with flexible turbulator.

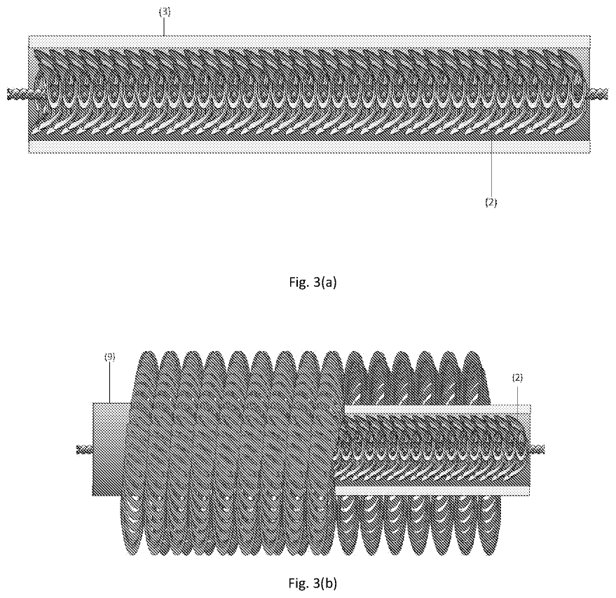

FIG. 4 illustrates a reactor assembly with re-circulation tank for completion of reaction.

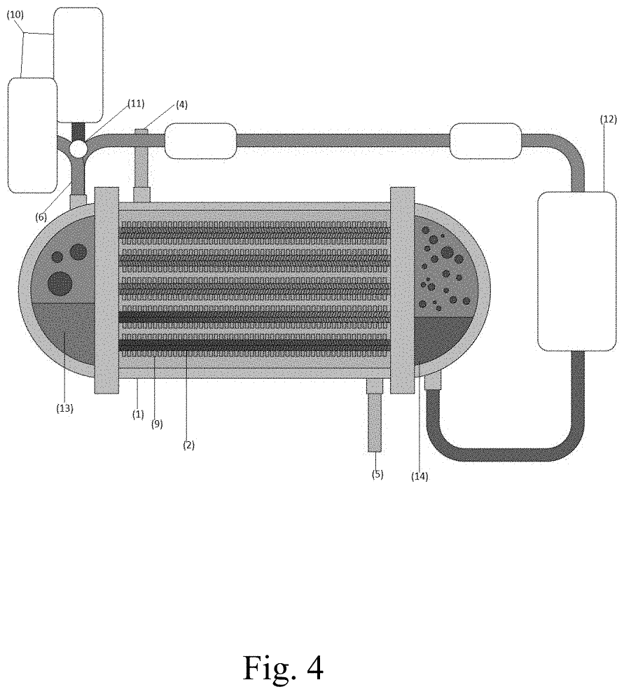

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

Various embodiments of the present invention provides a chemical reactor with flexible turbulators for efficient mixing or reaction of two or more reactants in a shell and tube assembly.

The terms “reactor”, “chemical reactor”, “assembly”, “reactor assembly” may be used interchangeably in the following detailed description. The words “reactants” “chemicals” “raw materials” may be used interchangeably in the following detailed description. The terms “thermal gradient” and “temperature gradient” may be used interchangeably in the following detailed description.

The following method is designed to provide for various applications in academia and industries requiring efficient chemical mixing and reactions of gas, liquids, solids, with or without catalysts undergoing exothermic or endothermic reactions.

The following method is designed to carry out chemical reactions in the reactor efficiently by use of flexible turbulators to provide effective mixing of reactants and heat transfer across the thermal gradient providing effective temperature control for the reactions in the reactor tube.

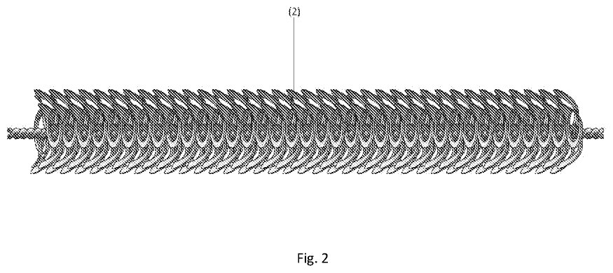

In one embodiment of the present invention, the chemical reactor is a shell and tube apparatus (15) in a horizontal arrangement or vertical arrangement as required. A flexible turbulator (2) is placed inside the tube (3). The turbulator can be a rigid turbulator or a flexible turbulator (2). However, flexible turbulator (2) as illustrated in FIG. 2 are more effective in stirring and mixing of reactants inside the tube (3). The reactants can be added into the reactor through one or more inlets (6). The reactants can be pre-mixed and added together through the inlet (6) for the reaction or one reactant can be added to the tube and the other reactant can be added subsequently at once or gradually, as required. This method is useful for gas-gas reactions, gas-liquid reactions, liquid-liquid reactions, and other combinations as required with or without catalysts. Once the reactants are added in the tube through the inlet, they are passed through the flexible turbulator (2) which causes the reactants to move in a haphazard manner creating Eddie currents. The reactants moving from the inlet (6) end of the tube to the outlet (7) end in haphazard manner causing the reactants to have continuous attrition which causes the tube wall to get heated in exothermic reactions and tube wall to get cooled in endothermic reactions. The shell fluid (8) present outside the tube (3) in contact with tube wall is temperature controlled to provide heat to the reaction mixture inside the tube (3) in case of endothermic reactions or to absorb heat from the reaction mixture inside the tube (3) in cases of exothermic reactions.

In another embodiment of the present invention, the reaction mixture is circulated back into the reactor for further mixing and the process is repeated until the final product is achieved.

In yet another embodiment, the flexible turbulator used is designed to reduce the size of gas bubbles inside the reaction mixture in the tube and avoid coagulation of the bubbles.

In yet another embodiment of the present invention, the flexible turbulator is designed to reduce particle size of the solids and facilitate distribution of the solid particles in fluid uniformly for efficient reaction.

In yet another embodiment of the present invention, multiple temperature sensors are placed inside the reactor to monitor the temperature of the reaction mixture. Temperature of the shell fluid is adjusted according to the temperature of the reaction mixture to facilitate thermal diffusion across the temperature gradient. The temperature of the reaction mixture would indicate the progress of the reaction. The data is monitored closely across narrow temperature gradients for effective control of the reaction and efficient final product.

In yet another embodiment of the present invention, if the reaction is not complete by the time the fluids or reactants flow from one end of the tube to the other end facilitated by the flexible turbulator, the reaction mixture is circulated back again to the tube for further mixing and reaction. The same process is repeated until the reaction is complete and final product is obtained.

In yet another embodiment of the present invention, in highly exothermic reactions, the tube of the reactor can be a fin tube (9). The fins allow more thermal dissipation from the tube to the shell fluid due to higher surface area.

Although the embodiments herein are described with various specific embodiments, it will be obvious for a person skilled in the art to practice the invention with modifications. However, all such modifications are deemed to be within the scope of the claims.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the claims.

### Advantages of the Invention

The present invention discloses an efficient method of chemical reaction in a heat exchanger chemical reactor. The method reduces the space and volume of containers required for carrying out chemical reactions. Further, presence of flexible turbulator reduced the lumen formation on inner wall of the tube to achieve maximum heat exchange.

I claim:

1. A chemical reactor for carrying out inline mixing of reactants comprises:
A shell and tube assembly, inlet (4) and outlet (5) for fluids in tube and shell, flexible turbulator and reactants;
wherein the chemical reactor consists of at least one shell (1) and tube (3) reactor assembly;
wherein the tube enclosed in the shell in selected from normal (3) and fin tubes (9);
wherein the chemical reactor consists of at least one turbulator for mixing reactants in the tube;
wherein the chemical reactor consists of at least one inlet (6) and one outlet (7) for inflow of reactants in the tube and outflow of intermediate or product from the tube;
wherein the chemical reactor consists of at least one inlet (4) and one outlet (5) for inflow of fluid in the shell and outflow of fluid from the shell;
at least two reactants for reaction in the tube (3);
at least one system to monitor temperature and rate of mixing of fluids inside the tube.

2. The chemical reactor as claimed in claim 1,
wherein the turbulator is present inside the tube and is a flexible turbulator (2).

3. A method of reaction in a chemical reactor comprises:
passing more than one reactant through the tube containing flexible turbulator (2) for mixing the reactants in exothermic or endothermic reaction;

4. The method of reaction as claimed in claim 3,
wherein the reactants are selected from the groups of miscible, immiscible liquids, solids, solid catalysts, liquid catalysts, gases.

5. The method of reaction as claimed in claim 3,
wherein the shell side fluids are selected from steam, thermic fluid, water, glycol, coolant.

6. The method of reaction as claimed in claim 3,
wherein the turbulators are statically agitating the reactants to facilitate homogeneous and effective mixing of the reactants.

7. The method of reaction as claimed in claim 3,
wherein the heat is transferred across the tube wall to the shell fluid and from shell fluid to the reactants through the tube wall across the temperature gradient.
